(19) United States
(12) Patent Application Publication
(10) Pub. No.: US 2014/0102002 A1
(43) Pub. Date: Apr. 17, 2014

(54) GASIFICATION OF BIO-OIL AND ALKALI CONTAINING ENERGY RICH AQUEOUS SOLUTIONS FROM PULP MILLS

(71) Applicants: Erik Furusjo, Stockholm (SE); Ingvar Landalv, Kungsangen (SE); Ragnar Stare, Saltsjo-boo (SE)

(72) Inventors: Erik Furusjo, Stockholm (SE); Ingvar Landalv, Kungsangen (SE); Ragnar Stare, Saltsjo-boo (SE)

(73) Assignee: CHEMREC AB, Stockholm (SE)

(21) Appl. No.: 14/112,957

(22) PCT Filed: Apr. 26, 2012
(86) PCT No.: PCT/SE12/50441

§ 371 Date: Dec. 26, 2013

(30) Foreign Application Priority Data
Apr. 26, 2011 (SE) 1150362-0

(51) Int. Cl. C01B 3/32

(52) U.S. Cl. CPC C01B 3/323
USPC 48/197 FM

(57) ABSTRACT

Process for gasification of an alkali containing energy rich aqueous solution (120) from a pulp mill in an entrained flow gasification reactor (2), the process comprising the steps of d) Supplying said alkali containing energy rich aqueous solution (120) to said gasification reactor (2), e) Gasifying said alkali containing energy rich aqueous solution (120) in the reactor (2) by using an oxidizing medium at sub-stoichiometric conditions and at a temperature below 1400 C in an outlet of said reactor (2); and, f) Producing a phase of a liquid material and a phase of a gaseous material in said reactor (2). wherein in step (a) supplying a bio-oil (110) to said gasification reactor (2), in step (b) simultaneously gasifying said alkali containing energy rich aqueous solution (120) and said bio-oil (110) in the reactor (2).

### FIELD OF THE INVENTION

The present invention relates to the field of generating energy-rich synthesis gas from renewable energy sources, more specifically through gasification of alkali containing energy rich aqueous solutions from pulp mills. More specifically, the invention relates to a process for gasification of an alkali containing energy rich aqueous solution from a pulp mill in an entrained flow gasification reactor, the process comprising the steps of supplying said alkali containing energy rich aqueous solution to said gasification reactor, gasifying said alkali containing energy rich aqueous solution in the reactor by using an oxidizing medium at sub-stoichiometric conditions and at a temperature below 1400° C. in an outlet of said reactor; and producing a phase of a liquid material and a phase of a gaseous material in said reactor.

### BACKGROUND INFORMATION

There is a need to find efficient technologies and to develop known technologies further to convert renewable energy sources to useful energy. Biomass is one of the renewable energy sources of great interest.

Biomass is biological material from living, or recently living organisms, such as wood or organic waste. Although fossil fuels have their origin in ancient biomass, they are not considered biomass by the generally accepted definition because they contain carbon that has been “out” of the carbon cycle for a very long time. Their combustion therefore increases the carbon dioxide content in the atmosphere.

Biomass energy is derived from a multitude of sources, such as wood, waste, and landfill gases. Wood energy is derived both from direct use of harvested wood as a fuel and from wood waste streams. An important source of energy derived from wood is pulping liquor or “black liquor,” a by-product product from processes of the pulp and paper industry. Waste energy is another large source of biomass energy. The main contributors of waste energy are municipal solid waste (MSW), manufacturing waste, and landfill gas.

Industrial biomass can be grown from numerous types of plants, including miscanthus, switchgrass, hemp, corn, poplar, willow, sorghum, sugarcane, and a variety of tree species.

There are a number of technological options available to make use of a wide variety of biomass types as a renewable energy source. Conversion technologies may release the energy directly, in the form of heat or electricity, or may convert it to another form, such as liquid biofuel or combustible biogas. While for some classes of biomass resource there may be a number of usage options, for others there may be only one appropriate technology.

One of the technological options available is thermal conversion which includes processes in which heat is the dominant mechanism to convert the biomass into another chemical form. The basic alternatives of combustion, torrefaction, pyrolysis, and gasification are separated principally by the extent to which the chemical reactions involved are allowed to proceed (mainly controlled by the availability of oxygen and conversion temperature).

Gasification is a process that converts carbonaceous materials, such as coal, petroleum, biofuel, or biomass, into carbon monoxide and hydrogen by reacting the raw material at high temperatures with a controlled amount of oxygen and steam and/or water. The resulting gas mixture is called synthesis gas or syngas and is itself a fuel. Gasification is a method for extracting energy from many different types of organic or fossil materials.

The advantage of gasification is that using the syngas is potentially more efficient than direct combustion of the original fuel because it can be combusted/utilized in a more flexible manner. Syngas may be burned directly in internal combustion engines or gas turbines to generate electricity, used to produce methanol, ammonia, hydrogen or synthetic diesel. The latter product is normally produced via the Fischer-Tropsch process.

Biomass gasification is expected to play a significant role in a renewable energy economy, because biomass production is neutral with respect to CO₂ in the atmosphere and the net effect of using biomass for e.g. fuel production is that it lowers CO2 concentration in the atmosphere compared to if fossil derived fuels would be continued to be used. While other biofuel technologies such as biogas and biodiesel production are also beneficial fuel sources for reducing carbon emissions, gasification runs on a wider variety of input materials, can be used to produce a wider variety of output fuels and is a very efficient method for extracting energy from biomass. Biomass gasification is therefore one of the most technically and economically viable energy conversion routes for a carbon emission constrained economy.

Three main types of gasifiers are currently available for commercial use: fixed bed, fluidized bed and entrained flow gasifiers. In the entrained flow gasifier a dry pulverized solid or a liquid fuel or fuel slurry is gasified with oxygen or air in co-current flow and the gasification reactions take place in a dense cloud of very fine particles/droplets. Most coals are suitable for this type of gasifier because of the high operating temperatures and because the good contact achieved between the coal particles and the gasifying agent. Entrained flow gasifiers have been demonstrated as highly effective units for the gasification of coal and other carbonaceous fuels such as residual oils and petcoke.

Black liquor, which is obtained from chemical pulping of wood chips in a pulping process, typically contains more than half of the energy content of the wood chips fed into the digester. Said black liquor needs to be concentrated, conventionally by evaporation, to a higher dry solids content, normally to 65-80%, by multi-effect evaporators before being fed to either a recovery boiler or a gasification plant to produce energy and recover the cooking chemicals.

Other effluents comprising biomaterial waste from pulp mills are e.g. bleach effluents from bleaching of paper pulp. Typically, these effluents have low solids content and lower energy content than spent cooking liquors, such as black liquor. In order to being able to burn or gasify said effluents, the effluents would have to be evaporated to such an extent that the net amount of energy produced would be very low.

A major challenge for gasification technologies is to reach an acceptable energy efficiency for fuels with low energy content, low reactivity or other undesired properties. The high efficiency of converting syngas to fuels or electric power may be counteracted by significant power consumption in the feedstock preprocessing, the consumption of large amounts of pure oxygen (which is often used as gasification agent), and gas cleaning. Another challenge becoming apparent when implementing the processes in real life is to obtain long service intervals in the plants, so that it is not necessary to close down the plant every few months for cleaning or maintenance.

In many gasification processes most of the inorganic components of the input material, such as metals and minerals, are retained in the ash. In some gasification processes in which the inorganic material is melted when passing the hot part of the gasifier (slagging gasification) this ash can have the form of a glassy solid with low leaching properties, but the energy efficiency in slagging gasification can be lower due to the higher temperature.

Furthermore, there are several problems associated with the use of biomass as energy source, some of which are a high bulk volume and a low calorie-value caused e.g. by high moisture content, high oxygen content or high inorganic content. Biomass is furthermore sensitive to moisture, difficult to feed to a pressurized gasifier, costly to grind, inhomogeneous and comprises metals which lead to a problematic handling of ashes when being gasified. Other problems associated with gasification of biomass are low ash melting point and a chemical composition with potentially high chlorine content. Several of said drawbacks and/or problems result in a decrease in overall efficiency, deposit formation (slagging and fouling), agglomeration, corrosion and difficult ash handling and also complicated and expensive process solutions in order to handle the various problems mentioned above.

In order to reduce said problems biomass may be pre-treated in some way before the gasification is performed. One way is to pyrolyze the biomass to provide a biomass pyrolysis oil, which is a dark, oily liquid. Pyrolysis is normally performed at temperatures between 400-600° C. and generates a gas as well as a liquid and a solid fraction. The two latter ones can, depending on pyrolysis process, be combined to form a pyrolysis oil containing 80-85% of the energy in the biomass fed to the pyrolysis process.

Gasification of pyrolysis oil in an entrained flow gasifier has been carried out in pilot plant scale at 25 bar pressure and with oxygen and steam as gasification media. In order to achieve acceptable gasifier performance a minimum of 99% of the carbon contained in the bio-oil feedstock has to be converted to gas (CO and CO₂) in the gasifier. The pilot plant tests have shown that a carbon conversion of 99% or more requires a gasification temperature of 1200-1600° C. depending on the composition of the pyrolysis oil. This high temperature leads to a high consumption of oxygen and lowers the cold gas efficiency of the gasifier (cold gas efficiency defined as energy in produced syngas divided by energy in the fuel to the gasifier) which means lower content of chemical currency (CO+H₂) in the produced syngas. A typical cold gas efficiency for entrained flow pyrolysis oil in pilot scale is 50-55%. Furthermore, handling of pyrolysis oil ash content is known to present difficulties in gasifier design. The normal ash content of pyrolysis oil is 0-5%.

Other renewable energy rich liquids are wood extractives, e.g. tall oil, that are byproducts from pulping and glycerol that is for example produced as a by-product from bio-diesel production. Heating values are typically higher than for black liquor.

Glycerol gasification is feasible, as described for example in document U.S. Pat. No. 7,662,196. The process described in that patent uses gasification in an entrained flow reactor at 900-1000° C. but due to the incomplete conversion of the feedstock to syngas, a second reaction step is required. The second step is a reformer wherein, also at temperatures above 900° C., the different partial oxidation/thermal cracking reactions in the presence of metal oxides are completed. Complete conversion in one step would require significantly higher temperatures and hence lead to low efficiencies, similarly as described above for pyrolysis oil gasification.

Another pre-treatment alternative may be to torrefy the biomass. Torrefaction of biomass may results in a dry biomass which is grindable and of higher density as well as of a higher energy density. The torrefied biomass may be feedable, e.g. as pellets or powders, which are, furthermore, more homogenous in composition but feeding torrefied solid biomass material to a pressurized gasifier may often be difficult, and, hence, it is preferred to have said torrefied solid biomass material pumpable by fedding it as a slurry. However, mixing torrefied solid biomass material with water would considerably lower the energy efficiency of the gasification.

With entrained flow gasifiers operating with coal-biomass mixture fuels, one problem is the delivery of the feedstock mixture of carbonaceous solids and biomass to the gasifier. Different types of entrained flow gasifiers, feeding solid coal or coal-water slurries, have been reported to encounter feedstock delivery as one of the hurdles to continuous running. Failure of slurry pumps and the clogging of lock hoppers have been observed. It is therefore desirable to develop a way of feeding biomass to entrained flow gasifiers which does not suffer from these disadvantages.

Document WO 2010/046538 shows that the catalytic effect of black liquor alkali can be utilized to increase reaction rates in decomposition of organic material. The process described in this document is a hydrothermal treatment process in super-critical or near-critical conditions with water as oxidizing agent and hence not relevant for gasification processes utilizing oxygen or air as oxidizing agent i gaseous phase.

Document US 2010/0083575 relates to a process for co-gasification of carbonaceous solids, such as coal and coke, with biomass in which the biomass material is pyrolyzed to provide a biomass pyrolysis oil and biomass char or coke which are then mixed with the carbonaceous solid to form a slurry. However, the process still uses carbonaceous solids as part of the feedstock, i.e. the raw material is not a biomass raw material exclusively. Furthermore, this process does not give any advantages in terms of lower gasification temperatures and/or higher efficiencies. This means that said document does not deal with the problems associated with gasification of biomass solely.

Taking the above into consideration there is a need to improve the process for biomass gasification and to increase the energy conversion efficiency.

### SUMMARY OF THE INVENTION

It is an object of the present invention to overcome or at least minimize at least one of the drawbacks and disadvantages of the above described technologies to convert renewable energy sources to useful energy. This can be obtained by a process as defined in the claims.

Thanks to the invention where alkali containing energy rich aqueous solution from pulp mills and bio-oil are gasified simultaneously, i.e. alkali containing energy rich aqueous solution and bio-oil are gasified together as a mixture in a reaction zone of a gasification reactor, it is possible to optimize the feedstock to be gasified so that said feedstock has appropriate properties for being efficiently gasified at lower temperature than would be required for gasification of only the bio-oil and preferably with less energy consuming pre-treatment for the alkali containing energy rich aqueous solution such as evaporation. This leads to a higher total energy efficiency of the process.

Furthermore, conventionally, the amount of available alkali containing energy-rich aqueous solution comprising material from the pulp mills restricts the size of the gasification plants. Thanks to a solution according to the invention, gasification plants of substantially higher capacity than conventional may be built at the pulp mills since bio-oil may be added to said alkali containing energy-rich aqueous solutions, which leads to substantially lowered specific investment costs.

According to one aspect of the invention, said alkali containing energy rich aqueous solution and said bio-oil are mixed and supplied as a feedstock mixture to the gasification reactor. Thanks to this aspect feedstock inlets may be made simpler.

According to another aspect, alkali containing energy rich aqueous solution (120) and said bio-oil (110) are supplied through separate inlets (3, 3′) arranged on the same burner of said reactor (2) ensuring good mixing in the reactor close to the inlets. Thanks to this aspect also materials that cannot be mixed or does not form a homogeneous solution can be gasified together.

According to a further aspect of the invention, the ratio (wt/wt) of alkali containing energy rich aqueous solution (120) and bio-oil (110) which are to be gasified in said reactor zone of the gasifier is between 95:5 and 20:80, more preferred between 90:10 and 40:60, and most preferred between 80:20 and 40:60. Thanks to this aspect optimized water content, alkali content and viscosity of the liquid to be gasified are achieved at maximum cold gas efficiency.

According to another aspect, said bio-oil (110) comprises biomass pyrolysis oil, glycerol and/or liquid by-products, e.g. tall oil from the pulp mill, and said alkali containing energy rich aqueous solution (120) comprises spent liquor from a pulping step within the pulp mill and/or a bleach effluent from one or several bleaching steps within the pulp mill. Thanks to this aspect a flexible process is obtained with a possibility of gasifying a variety of liquids and mixtures according to the specific location of the gasification plant and situation at the site.

According to yet another aspects of the invention, the gasification process is carried out at an absolute pressure of the gasification process from about 1.5 to about 150 bar, preferably from about 10 to about 80 bar, and most preferably from about 24 to about 40 bar in the reaction zone and at a temperature which is at least 900° C., preferably at least 950° C. but below 1400° C., preferably below 1200° C., in the reaction zone during the gasification. Thanks to these aspects optimal conditions are achieved during the gasification and subsequent heat recovery and maximal energy efficiency are obtained.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a flow scheme for a set up of processes for carrying out the invention,

FIG. 2 shows a flow scheme for an alternative set up of processes for carrying out the invention,

FIG. 3 shows a general process scheme of a gasification plant of the entrained- flow, high temperature reactor type, and

FIG. 4 shows a modified version of the gasification plant as shown in FIG. 3.

### DETAILED DESCRIPTION OF THE PREFERRED EMBODIMENTS

The following detailed description, and the examples contained therein, are provided for the purpose of describing and illustrating certain embodiments of the invention only and are not intended to limit the scope of the invention in any way.

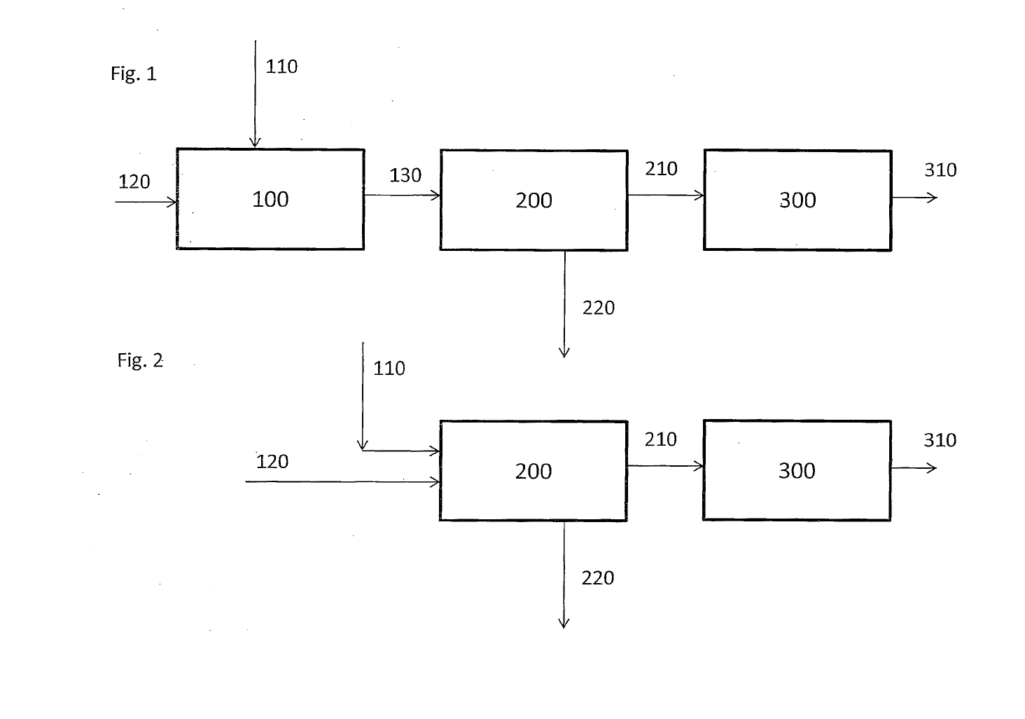

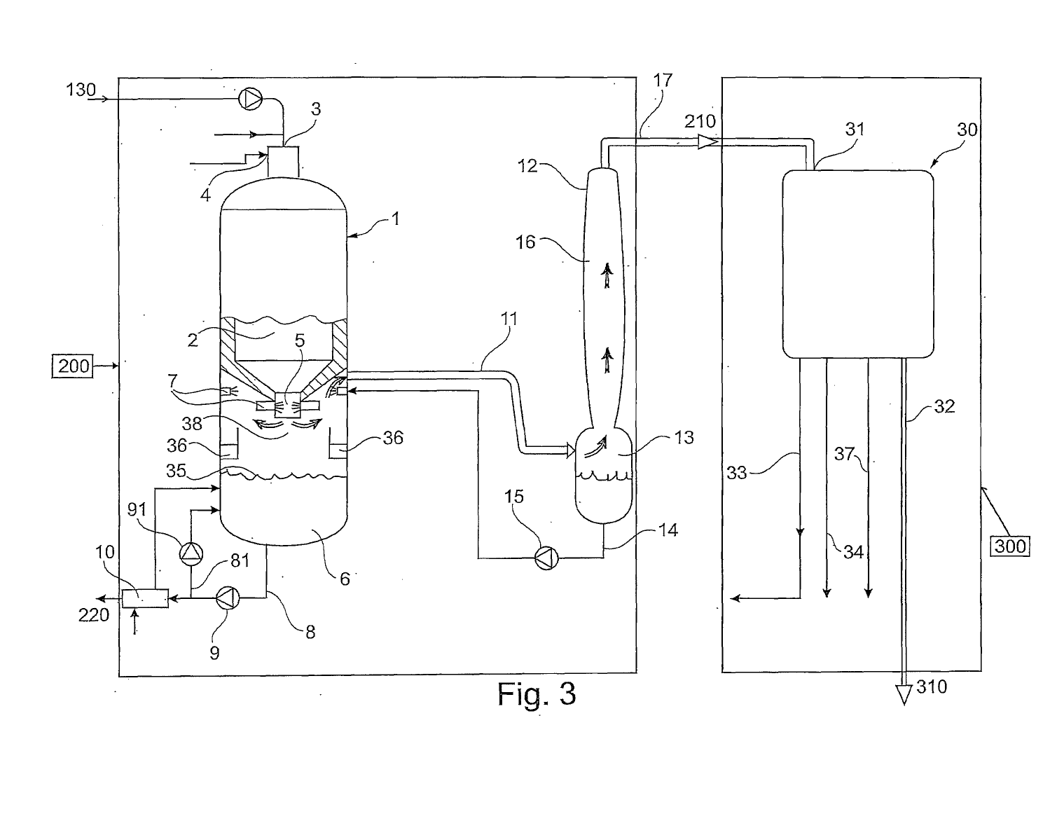

In FIG. 1 a flow scheme for a set up of processes for carrying out the invention is shown. Bio-oil 110 is fed to a feedstock mixing tank 100, where bio-oil 110 is mixed with alkali containing energy-rich aqueous solution 120 from a pulp mill. The resulting feedstock mixture 130 comprising the alkali containing energy rich aqueous solution 120 and the bio-oil 110 is supplied to a gasification reactor 2 (shown in FIG. 3) of an entrained bed gasification process 200, in which reactor 2 said feedstock mixture 130 is gasified and converted into a raw synthesis gas 210 and a so called green liquor 220 comprising recovered pulping chemicals. After the raw synthesis gas 210 has been cleaned and conditioned in one or several after treatment units 300 the clean syngas 310 may be used for efficient production of electric power and/or production of fuels or chemicals.

Said bio-oil 110 may be any type of liquid derived from biomass material, preferably pyrolysis oil from wood, glycerol from biodiesel production, or tall oil from wood, vegetable oils etc while said alkali containing energy-rich aqueous solution 120 may preferably be a spent liquor from a pulping process in a pulp mill or an effluent from the pulp mill.

The term bio-oil is understood to comprise all renewable energy rich liquids with origin in biomass, e.g. pyrolysis oil, glycerol, tall oil etc. Different liquors produced as waste or by-products within the pulp mills when producing paper pulp, e.g. spent liquors and effluents, are not included in the term bio-oil throughout the text.

Depending on the chemical pulping process used, the resulting spent liquor will have different chemical composition and also be termed differently. For Kraft pulping processes the spent liquor is a so called black liquor. Typically, the black liquor contains more than half of the energy content of the wood chips fed into the digester. Other chemical pulping processes may be different sorts of sulphite pulping processes, e.g. sodium or potassium based sulphite processes, resulting in a sodium or potassium based sulphite spent liquor.

Alternatively, said alkali containing energy rich aqueous solution 120 comprising energy-rich material may preferably be an effluent from the pulp mill, e.g. an effluent from a bleaching step within the mill. It may in some embodiments be a mixture of appropriate spent liquors and effluents so as to reach an appropriate total solids content, alkali content and/or viscosity. The alkali metal content of the alkali containing energy rich aqueous solution catalyzes the gasification and decomposition reactions, enabling very high carbon conversion at comparably low gasification temperature.

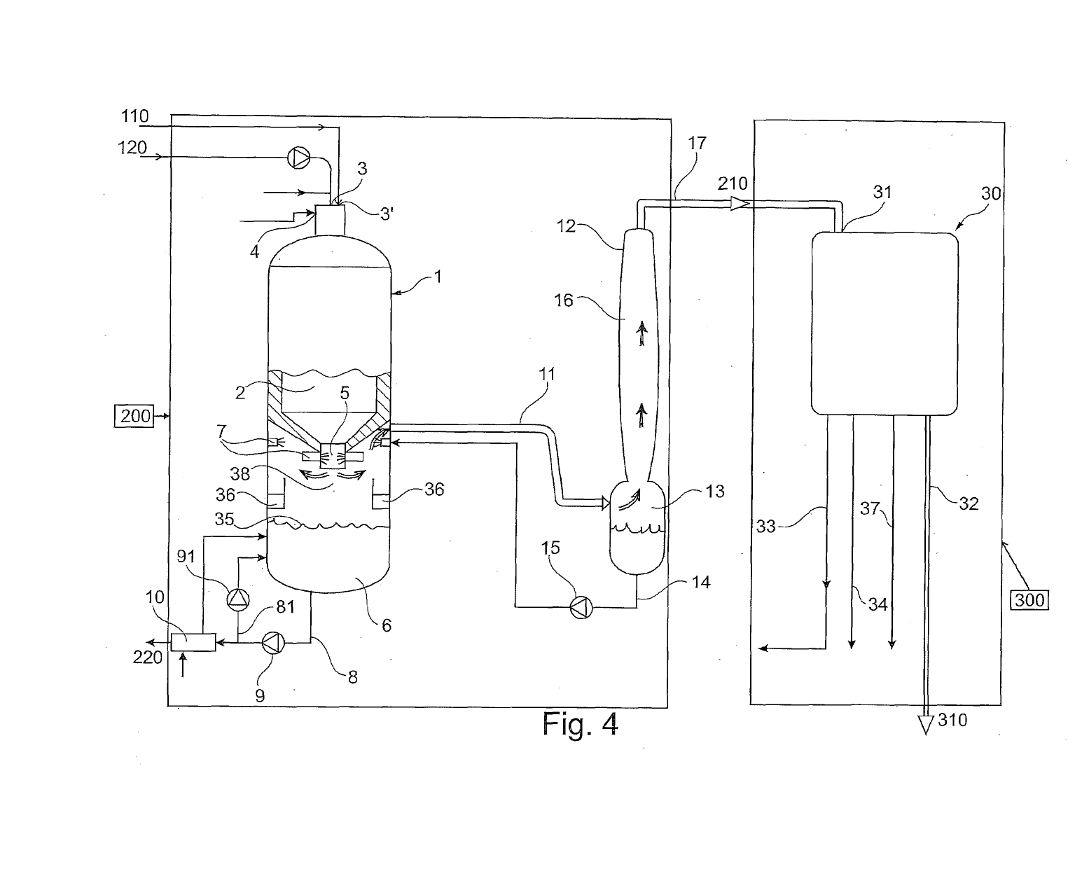

Hence, the alkali metal content of the mixture has to be high enough to give sufficient catalytic effect. Alternatively, alkali may be added, e.g. as NaOH, to the mixture or to the bio oil in embodiments where alkali containing energy rich aqueous solution and the bio oil are fed to the reactor through separate inlets (FIGS. 2 and 4) in order to achieve the catalytic effect. This addition may preferably be a part of the alkali make-up to the pulp mill chemical cycle.

Bio-oil normally has a higher heating value than said spent liquors, which in turn have higher heating values than said bleach effluents. Addition of bio-oil to spent liquors may increase cold gas efficiency of gasification of alkali containing energy rich aqueous solution. This is achieved e.g. by decreasing the relative losses of energy from the reactor or by lowering the relative amount of energy required to evaporate and heat the water content of the aqueous solution gasification in the gasification reactor. Addition of bio-oil to bleach effluents may indeed motivate gasification of bleach effluents from an economical point of view.

Said bio-oil may be manufactured from a biomass material comprising plant matter but said biomass material may also include discarded plant or animal matter which has been primarily used for other purposes such as production of food, production of fibers, chemical manufacturing or heat production. Furthermore, the biomass material may also biodegradable wastes that can be burnt as fuel including municipal wastes, green waste (the biodegradable waste comprised of garden or park waste such as grass or flower cuttings and hedge trimmings), byproducts of farming including animal manures, food processing wastes, sewage sludge or algae.

In FIG. 2 another preferred embodiment of the invention is shown, in which the alkali containing aqueous solution 120 and the bio-oil 110 are mixed inside the gasification reactor 2 (shown in FIG. 4) of the gasification process 200 after being introduced/supplied via separate conduits through separate inlets of the gasification reactor 2.

Introduction of water and/or steam may often be required to counteract soot formation in bio-oil gasification. However, introducing water in the reactor generally decreases the cold gas efficiency. By mixing bio-oil 110 and the alkali containing aqueous solution 120, the water in said aqueous solution 120 is utilized, meaning that no extra water and/or steam may have to be added that would otherwise decrease cold gas efficiency for gasification of the bio-oil 110.

Handling of inorganic components (ash) is a key function of a spent cooking liquor gasifier, since inorganic chemicals in the black liquor have to be recovered and recycled to the mill. When the ash from the bio-oil 110 is mixed with the ash from spent cooking liquor 120 in the gasification reactor, a mixture with similar melting temperature and properties as the spent cooking liquor ash is formed. Thus, the ash handling problem that is present in bio-oil gasification may be solved if a feedstock comprising a bio-oil/spent cooking liquor mixture is gasified in a gasifier of the same type that is normally used for spent cooking liquor.

FIG. 3 shows a general process scheme of a gasification process of the entrained-flow reactor type for gasification at slagging conditions (high temperature) in accordance with the invention. Said process being a part of a chemical recovery cycle for a kraft or sulphite pulp mill.

The following description is to be seen as a general description of a gasification process and shall be interpreted as illustrative and not in a limiting sense. It is to be understood that numerous changes and modifications may be made to the below described process, without departing from the scope of the invention, as defined in the appending claims.

The process scheme is however illustrating the embodiment as described in relation to FIG. 1 with a premix of the alkali containing energy rich aqueous solution 120 and bio-oil 110 as the feedstock mixture 130.

FIG. 3 shows an equipment for down-draft gasification, i.e. gasification with a gasification burner positioned on top or substantially on top of the gasification reactor. Reference number 1 in FIG. 3 denotes a pressure vessel which comprises a ceramically lined gasification reactor 2 followed by a quench compartment 38 in which the hot media, i.e. a phase of liquid material and a phase of gaseous material, from the reactor is cooled by a cooling liquid. The reactor is provided with an inlet 3 for the feedstock mixture 130 and an inlet 4 for an oxidizing medium, e.g. oxygen or oxygen-containing gas and a burner (not shown). Said inlets 3, 4 are preferably arranged on the upper portion of the gasification reactor 2. In the embodiment shown in FIG. 3 said inlets 3, 4 are arranged substantially on top of the dome of said gasification reactor 2. However, in other embodiments it may be preferred to place the inlets on other locations of said gasification reactor 2. There may also be an inlet for atomizing support medium (not shown). Said inlet for atomizing support medium may preferably be arranged in vicinity of the other said inlets so as making it possible to mix said atomizing support medium with the oxidizing medium and/or the fuel in the burner. The opening in the bottom of the reactor chamber is limited in size to give a recirculating flow pattern in the reactor, which is required to give high carbon conversion and sulphur reduction efficiency. The opening is in the form of a chute 5, which opens directly into the quench compartment 38 above the surface 35 of the liquid in a green liquor liquid chamber 6 which is situated below. One purpose of the quench compartment 38 is to cool the gas leaving the reactor to a temperature at which gas phase chemical reactions does not take place at a significant rate.

A number of spray nozzles 7 for cooling liquid open out into the chute 5 and the quench compartment 38. Green liquor 220 which is produced is transported from the chamber 6 through a conduit 8, via a pump 9 and a heat exchanger 10, to subsequent process stages for generating cooking liquor, e.g. white liquor, or to another process stage in which green liquor is employed. A partial flow of the green liquor transported in conduit 8 may be returned to the green liquor liquid chamber 6 through a conduit 81 via a pump 91. Cooling liquid that is not evaporated is collected in a volume 36 to be reused.

Raw synthesis gas from the first vessel 1 is conveyed through a conduit 11 to a second pressure vessel 12 for gas treatment and sensible heat energy recovery. This conduit 11 opens out in the pressure vessel 12 above the surface of a liquid in a washing chamber 13 at the bottom of the vessel. The liquid in the washing liquid chamber of the second vessel may be conveyed, through a conduit 14 via a pump 15, to the first vessel 1 in order to serve as diluting liquid or as a cooling liquid which is provided via the spray nozzles 7. The pressure vessel 12 may comprise an indirect condenser of the counter-current falling-film condenser type 16 located above the chamber 13. Other types of condensers may be used without departing from the scope of the invention and since methods for gas washing and gas cooling are well known techniques it will not be described in detail here.

An outlet conduit 17 for cooled raw synthesis gas 210 is located at the top of the second pressure vessel 12. The outlet conduit 17 transports the cooled raw gas from the gasification plant 200 to an inlet 31 of the one or several after treatment units 300 which may comprise a plant 30 for further removal of sulphurous components and most of the CO₂ (acid gas removal, AGR). The plant 30 comprises any gas separation technology for acid gas removal as well as gas conditioning technology as may be needed to produce high quality synthesis gas. In a preferred embodiment selective removal of non-desired gas components in raw syngas 210 is performed so that sulphur containing components, CO₂ and traces of tar components which may be present in raw syngas 210, are removed separately in conduits 33, 34, 37, respectively. A conduit 32 of the plant 30 may transport the purified and cooled synthesis gas 310 now called cleaned synthesis gas, to any field of use of the synthesis gas, e.g. chemical production, fuel production, electricity generation and/or steam/heat generation.

FIG. 4 shows a general process scheme of a modified version of the gasification process of the entrained-flow type for down-draft gasification at slagging conditions (high temperature) as shown in FIG. 3 and in accordance with another preferred embodiment of the invention. Said process being a part of a chemical recovery cycle for a kraft or sulphite pulp mill.

The process scheme is illustrating the embodiment as described in relation to FIG. 2 in which the bio-oil 110 and the alkali containing energy rich aqueous solution 120 are brought separately via separate conduits to separate inlets 3, 3′ of the gasification reactor 2 for feeding of the alkali containing energy rich aqueous solution 120 and the bio-oil 110. The inlets 3, 3′ are positioned, preferably in vicinity of each other, so as to achieve a good mixing of said feeds when they have entered the reactor. The inlets 3, 3′ are preferably arranged on the upper portion of the gasification reactor 2. In the embodiment shown in FIG. 4 said inlets 3, 3′ are arranged on top or substantially on top of the dome of the gasification reactor (2) but the invention is not limited to the exact location of the inlets on the upper half of the gasification reactor 2. However, the inventors have found that it may be beneficial to place the inlets 3, 3′ relatively close to each other thereby enabling the use of the same gasification burner (not shown) for burning the feeds which may be beneficial since burning the feeds by using the same burner would ensure good mixing of the bio-oil and the alkali containing energy rich aqueous solution in the gasification reactor. This allows the catalytic effect of the alkali to be present also for the bio-oil gasification. By processes according to this embodiment it is possible to gasify combinations of the alkali containing energy rich aqueous solution 120 and the bio-oil 110 which are disadvantageous to mix or does not form homogeneous solutions.

A first preferred embodiment according to the invention is now to be described.

Kraft black liquor 120 having a dry solids content of about 70-85% is fed to the mixing zone 100 where said liquor 120 is thoroughly mixed with pyrolysis oil 110 and forming a feedstock mixture 130. The dry solids content of the black liquor may be lower than what would normally be used for gasification of the Kraft black liquor independently in order to achieve appropriate gasification feedstock mixture properties, e.g. water content, alkali content and viscosity, that are optimal for the gasification process of the feedstock mixture. The black liquor 120 and the pyrolysis oil 110 are mixed so as to form a mixed gasification feedstock 130 having a ratio (wt/wt) of black liquor 120 to pyrolysis oil 110 between 95:5 and 20:80, more preferred between 90:10 and 40:60 and most preferred between 80:20 and 40:60.

Said mixed gasification feedstock 130 may be heated to a temperature of 100-200° C. before entering the gasification reactor 2, if necessary, to achieve a viscosity which may more easily be processed conveniently in the gasifier 2. Said mixed gasification feedstock 130 is fed to the gasification unit 200 comprising the gasifier reactor 2 of the entrained flow type. Entrained flow gasifiers are known per se. However, in the preferred embodiments according to the invention the gasification may preferably be performed in an entrained flow type gasifier that may preferably be:
Equipped with means for atomizing the gasification feedstock into small droplets, preferably smaller than about 200 μm
Suited for gasification of a highly alkaline feedstock with high ash content from a material compatibility perspective
Equipped to achieve handling and recovery of the ash content in the gasification feedstock.
Connected with an acid gas removal unit that can remove/recover non-desired gas components such as traces of tars, sulphur containing components and CO₂ from the raw synthesis gas produced in the gasifier

The gasifying reactor 2 is fed with the feedstock mixture 130 and a stream of oxygen or an oxygen containing gas. Said stream may have been pre-heated to 50-400° C. The feedstock mixture 130 is processed by gasification in the presence of an oxidizing medium, e.g. oxygen or air, whereby heat is released by the chemical reactions taking place to give a temperature in the outlet of the reactor 2 above 800° C., preferably above 900° C., more preferred above 950° C. but below 1400° C., preferably below 1200° C., and at an absolute pressure of about 1.5 to about 150 bar, preferably about 10 to about 80 bar, and most preferably from about 24 to about 40 bar in the reaction zone (a so called high pressure gasification). An atomizing support medium may be used. Said gasification takes place at reducing conditions, i.e. sub-stoichiometric oxygen conditions, whereby producing a mixture of partly at least one phase of a liquid material and partly at least one phase of a gaseous material. It is important that the reactor bottom outlet is designed to give a recirculating flow pattern in the reactor in order to achieve the desired process performance.

It is to be interpreted that the temperature in the outlet of the reactor 2 means the mean temperature of the liquid material and the gaseous material when said materials are to leave the reactor 2, in the region adjacent the chute 5. The reaction temperature within the reactor 2 is usually considerably higher than the temperature in the reactor outlet.

The phase of gaseous material comprising the raw synthesis gas, e.g. carbon monoxide, hydrogen, carbon dioxide, methane, hydrogen sulphide, and aqueous steam, and the phase of the liquid material comprising inorganic smelt and ash, e.g. sodium sulphide, carbonate and hydroxide, are cooled in the quench compartment 38 by spraying cooling liquor through a number of nozzles 7 in order to achieve maximum contact with the gas/smelt mixture. The cooling liquid may principally consist of water, some of which water will be evaporated when it makes contact with the hot gas and the smelt at the reactor temperature. The gas temperature drops to approx. 100-300° C. in the quench compartment 38. The smelt drops are dissolved in the remaining part of the cooling liquid and falls into the green liquor liquid chamber 6 where it dissolves to form green liquor. Alternatively, the smelt drops fall down directly into the liquid chamber and only then dissolve in the green liquor which is already present in this location. The smelt drops are then possibly cooled by the evaporation of water in the green liquor bath.

The green liquor comes out from the bottom of the quench compartment 38 of the first pressure vessel through the conduit 8 and may be pumped through a heat exchanger, in which heat energy is recovered from the green liquor by cooling the latter. Alternatively, green liquor heat energy may be recovered by other means. A screen may be used ahead of the pump to catch small particles. It is beneficial that the amount of unburnt charcoal in the smelt and in said green liquor is lower than 5%, preferably lower than 1% and more preferred lower than 0.2%, of the carbon in the sulfite thick liquor. i.e. that the carbon conversion in the reactor is at least 95%, preferably at least 99% and more preferred at least 99.8%.

The green liquor sulphide may be recovered in the same manner as the sulphide in the green liquor from a recovery boiler. A high sulphur reduction efficiency decreases the total amount of sulphur that needs to be circulated by decreasing the so-called dead-load (i.e. inactive sulphur species such as sulphate). It is beneficial that the green liquor is to an extent of at least 90%, preferably at least 98% and more preferred at least 99%, free from non-reduced sulphur, i.e. that the sulphur reduction efficiency is at least 90%, preferably at least 98% and more preferred 99%.

The raw synthesis gas 11, leaving the primary quench dissolver of the reaction vessel 1, now essentially free of smelt drops, is further cooled to saturation in the second vessel 12, the gas cooler for particulate removal and gas cooling. Water vapour in the raw synthesis gas 11 is condensed, and the heat released may be used to generate steam.

Traces of tars, hydrogen sulphide and carbon dioxide may be removed from the cool raw synthesis gas in a so called acid gas removal plant 300—AGR. Several known commercial gas cleaning systems comprising units for absorption of acid gas and recovery of sulphur may be used. Said removed hydrogen sulphide may then be conveyed to the cooking liquor preparation.

The table below shows typical properties for pyrolysis oil gasification, black liquor gasification and co-gasification of pyrolysis oil and black liquor in a 50/50 mixture.

| | Pyrolysis | Black | |
|---|---|---|---|
| | oil (PO) | liquor (BL) | 50/50 |
| | gasification | gasification | BL/PO mix |
| Heating value (wet basis) | | | |
| MJ/kg] | | | |
| Typical | 15-20 | 9-10 | 12-15 |
| High | 25 | 12 | |
| Ash content [%] | 0-5 | 15-40 | 7-22 |
| Presence of catalyzing | Low | 10-20 | 5-10 |
| Na And K [%] | | | |
| Water [%] | 5-30 | 20-35 | 10-30 |
| Gasification temp | 1200-1600 | 1000-1050 | 1000-1050 |
| Carbon conversion | About 99% | >>99% | >>99% |

The pyrolysis oil 110 may be manufactured by pyrolysis of biomass material in any conventional manner resulting in a pyrolysis oil 110 that comprises primarily a mixture of organic chemicals and having a varying water quantity ranging from about 5 wt % to about 50 wt %.

In a second preferred embodiment sulphite spent liquor is mixed with pyrolysis oil. Sulphite spent liquor 120 having a dry solids content of about 60-80% is fed to the mixing zone 100 where said liquor 120 is thoroughly mixed with pyrolysis oil 110 and forming a mixed gasification feedstock 130.

The sulphite spent liquor and pyrolysis oil are mixed so as to form a feedstock mixture 130 having a ratio (wt/wt) of sulphite spent liquor 120 to pyrolysis oil between 95:5 and 20:80, preferably between 90:10 and 40:60 and most preferred between 80:20 to about 40:60.

The generally lower alkali content of sulphite spent liquor compared to Kraft black liquor may allow a lower proportion of pyrolysis oil to be mixed in without reaching too low alkali content in the mixed gasification feedstock 130.

Said mixed gasification feedstock 130 may be heated to a temperature of 100-200° C. before entering the reactor 2, if necessary, to achieve a viscosity which can more easily be processed conveniently in the gasifier and is then fed to the gasification unit 200 and being gasified in accordance to what is earlier described. The gasification process may preferably be similar to the one given for the description of the first preferred embodiment above.

Recovery of green liquor and sulphur in syngas is different for a sulphite pulping process, giving sulphite spent liquor, compared to a kraft pulping process, giving kraft black liquor as described above.

In a third preferred embodiment a bleach effluent 120 is mixed with glycerol 110.

Bleach effluent 120 from one or several bleaching steps is fed to the mixing zone 100 and mixed with glycerol 110. Depending on the properties of the bleach effluent, said effluent may be evaporated to some extent before being mixed with the glycerol 110 and forming the feedstock mixture 130. Bleach plant effluents typically has a dry solids content of about 40-70% after concentration by evaporation.

Bleach plant effluents are known to frequently be difficult to evaporate to high dry solids content. Furthermore, the heating value of the bleach plant effluents is often lower than for spent liquors from the pulping process. Both low dry solids content and low heating value decreases gasification process efficiency. Hence, gasification of bleach plant effluents separately may be difficult with acceptable process performance. As described above, the alkali content in the bleach plant effluent may be used to increase efficiency of bio-oil gasification reactions and the higher heating value of the bio-oil leads to higher efficiency in the gasification of a mixed gasification feedstock. The bleach plant effluent 120 and glycerol 110 are mixed so as to form a feedstock mixture 130 having a ratio (wt/wt) bleach plant effluent 120 to glycerol 110 between 95:5 and 20:80, preferably between 90:10 and 40:60 and most preferred between 80:20 to about 40:60.

Said feedstock mixture 130 is fed to the gasification unit 200 and being gasified in accordance to what is earlier described. The gasification process is similar to the one given for the description of the other preferred embodiments above.

It is understood that the objects of the present invention set forth above, among those made apparent by the detailed description, shall be interpreted as illustrative and not in a limiting sense. Within the scope of the following claims the set-up of various alterations of the present invention may be possible, for instance to use a combination/mixture of spent liquors and bleach effluents as said aqueous solution comprising energy-rich material. A combination/mixture may give an opportunity to more exactly adjust the viscosity and the water content of the slurry to be gasified.

The gasifier in the different embodiments of the invention is of the down-draft entrained-flow type but it is understood that other kinds of entrained flow gasifier may as well be used according to the invention, e.g. an up-draft type gasifier with the gasification burner located on the lower portion of the gasification reactor.

Furthermore, it is understood that other materials of biomass material origin than bio-oil may be gasified together with the alkali containing energy rich aqueous solution, e.g. torrefied biomass material in powdered or granular form.

It is also understood that for reactors having more than one inlet for feedstock there may be possible not only to feed different feedstocks through different inlets but to feed a mixture of feedstock through one inlet while simultaneously feed other feedstocks having other compositions through other inlets so as to reach e.g. appropriate viscosity and alkali content of the energy-rich materials to be simultaneously gasified, i.e. a mixture of two or more feedstocks, in the reactor zone. In embodiments where there are two inlets arranged on the gasifier it may for instance be preferred to feed a feedstock of black liquor through one inlet and a feedstock mixture of bio-oil and bleach effluent through a second inlet. Moreover, in embodiments where the gasification reactor is provided with a third inlet a feed of e.g. bio-oil may be added through said third inlet.

Furthermore, the wording “simultaneously gasifying” should be interpreted as being gasified together under the same gasification conditions in the reactor zone of the gasifier.

1-3. (canceled)

14. Process for gasification of an alkali containing energy rich aqueous solution from a pulp mill in an entrained flow gasification reactor, the process comprising the steps of:
a) supplying said alkali containing energy rich aqueous solution to said gasification reactor;
b) gasifying said alkali containing energy rich aqueous solution in the reactor by using an oxidizing medium at sub-stoichiometric conditions and at a temperature below 1400° C. in an outlet of said reactor; and
c) producing a phase of a liquid material and a phase of a gaseous material in said reactor, wherein in step (a) supplying a bio-oil to said gasification reactor, in step (b) simultaneously gasifying said alkali containing energy rich aqueous solution and said bio-oil in the reactor.

15. The process according to claim 14, further comprising supplying said alkali containing energy rich aqueous solution and said bio-oil as a feedstock mixture to the reactor.

16. The process according to claim 14, further comprising supplying said alkali containing energy rich aqueous solution and said bio-oil through separate inlets of said reactor.

17. The process according to claims 14, wherein said bio-oil comprises biomass pyrolysis oil, glycerol and/or liquid by-products from the pulp mill.

18. The process according to claim 17, wherein said liquid by-products comprises tall oil.

19. The process according to claim 15, wherein the ratio (wt/wt) of alkali containing energy rich aqueous solution and bio-oil is between 95:5 and 20:80.

20. The process according to claim 15, wherein the ratio (wt/wt) of alkali containing energy rich aqueous solution and bio-oil is between 90:10 and 40:60.

21. The process according to claim 15, wherein the ratio (wt/wt) of alkali containing energy rich aqueous solution and bio-oil is between 80:20 and 40:60.

22. The process according to claim 14, further comprising carrying out the gasification at an absolute pressure of the gasification process from about 1.5 to about 150 bar.

23. The process according to claim 14, further comprising carrying out the gasification at an absolute pressure of the gasification process from about 10 to about 80 bar.

24. The process according to claim 14, further comprising carrying out the gasification at an absolute pressure of the gasification process from about 24 to about 40 bar in the reaction zone.

25. The process according to claim 14, wherein said temperature is at least 900° C. in the outlet of the reactor during the gasification.

26. The process according to claim 14, wherein said temperature is at least 950° C. in the outlet of the reactor during the gasification.

27. The process according to claim 4, wherein said temperature is below 1200° C. in the outlet of the reactor during the gasification.

28. The process according to claim 14, wherein said liquid material being in the form a salt melt, dissolving said salt melt in a liquor in a green liquor bath thereby forming green liquor, and drawing off said green liquor and returning said green liquor to the pulp mill.

29. The process according to claim 14, wherein said gaseous material being a raw synthesis gas, and drawing off and conveying said raw synthesis gas to further processing whereby producing a synthesis gas.

30. The process according to claim 14, wherein said alkali containing energy rich aqueous solution comprises spent liquor from a pulping step within the pulp mill and/or a bleach effluent from one or several bleaching steps within the pulp mill.

31. The process according to claim 30, wherein said spent liquor comprises black liquor and/or sulphite spent liquor, said sulphite spent liquor being a sodium or a potassium based sulphite spent liquor or a mixture thereof.
